(19) United States
(12) Patent Application Publication
(10) Pub. No.: US 2005/0044476 A1
(43) Pub. Date: Feb. 24, 2005

(54) System and method for incorporating customized information in a booklet

(76) Inventor: Sidney L. Bursten, Baltimore, MD (US)

Correspondence Address: ROBERTS ABOKHAIR & MARDULA, SUITE 1000, 11800 SUNRISE VALLEY DRIVE, RESTON, VA, 20191, US

(21) Appl. No.: 10/635,773

(22) Filed: Aug. 6, 2003

(51) Int. Cl. G06F 17/21

(52) U.S. Cl. 715/500

(57) ABSTRACT

A system and method for incorporating customized content into a booklet. A content control identifier is read from a pre-printed custom booklet component and sent to a content controller. The content controller uses the content control identifier to obtain instructions from a datastore and uses the instructions to create one or more “just-printed” custom booklet components and marry them to pre-printed custom booklet component to create a customized booklet. In another embodiment, a generic booklet body is printed on a web-fed press. A content control identifier is read from a pre-printed custom booklet component and sent to a content controller. The content control identifier is used to trigger the personalization (for example, the addressing) of the generic output for a targeted recipient and to marry the preprinted signature from which the content control identifier was read to the personalized web-fed press output to form a customized booklet for the targeted recipient.

### FIELD OF INVENTION

The present invention relates generally to the field of creating publications. More particularly, the present invention is a system and method for incorporating personalized information into a booklet.

### BACKGROUND OF INVENTION

A booklet comprises a cover and inside pages (sometimes referred to as the “booklet body”). A wide variety of information is disseminated in booklet form, including paperback books, magazines and other periodicals, catalogues, instruction manuals, and even some form documents (e.g., insurance policies). The vast majority of booklets are printed on sheet-fed and web-fed offset lithographic presses, which are capable of rapidly producing thousands upon thousands of identical (generic) booklets.

Personalized printing is a process that creates individualized contents on blank or preprinted paper addressing individual messages to specific persons. The address printed directly on the covers of magazines is one frequent application of personalization, while others include a variety of other material ranging from invoices and statements, marketing messages and coupons, all the up to completely individualized, full color product catalogs.

Customized printing is a process in which all of the content of each component of the booklet (cover, body, and inserts) is intended for a specific recipient, and bears no necessary relationship to any component intended to any other recipient.

There are a variety of printing technologies (e.g., off-set, gravure, laser, ink-jet) that can be used to print on paper that is either in sheet form (a sheet-fed printer) or in roll (or web)-form (a web-fed printer). Additionally, a printer can be described as variable, meaning it can print documents of varying content as a single job. A variable printer is capable of printing a custom signature. (A signature comprises a sheet of paper printed on both sides that, when optionally folded and included in a document or booklet, constitutes a number of pages always divisible by 2 and typically 4 or some other power of 2.) A printer that is not variable is limited to printing a generic signature. Certain non-variable printers can be augmented with a second, lower quality printer to allow a generic signature to be personalized during the paper's travel from the feeding end to the delivery end. For the sake of clarity, the discussion that follows will focus on the attributes of the printed product (generic, personalized, and customized).

Both mass-production of identical printed output and customization have enormous advantages, but technical problems have limited the use of both techniques at the same time. Web-fed offset lithography enables extremely low costs, while customization substantially increases the marketing effectiveness of advertising, which pays the bills for magazines and catalogs.

The root of the difficulty is the substantial difference in printing speed of offset lithography, which without augmentation does not permit any personalization, and the various forms of digital printing, which allows each piece to have different content (sometimes referred to as “fully variable” printing). By way of illustration, high-capacity web offset presses used for popular magazines and high-circulation catalogs print 40,000 pages per minute and up per web, and presses are capable of printing several webs at once to yield 200,000 pages per minute and up. At extremely high volumes, a technology known as rotogravure can provide even greater speeds and capacity at lower per-unit costs.

By contrast, the fastest fully variable, color printer on the market today produces about 3,000 pages a minute—but at very low resolution inappropriate for use in most magazines and catalogs. The highest speed of variable color printers with quality comparable to offset production is under 150 pages per minute on web-fed presses, and about 100 pages per minute on sheet-fed presses.

Offset and rotogravure web presses may be adapted to provided limited customization capabilities by incorporating one or more ink-jet printers (or other high-speed, low-quality printers) into the presses to print custom text and graphics in designated locations based on the contents of a data file. By way of illustration, a customer address may be printed in a mailing block and a message may be printed in a message block as the web progresses through the web-fed printer. Custom content produced on the moving web by ink-jet and other such printers offer far lower resolution and print quality than the offset lithography or rotogravure processes that are printing the static and unchangeable content on the web.

A booklet printed on an offset or rotogravure printer may also receive an insert in the form of preprinted generic pages. The inserted generic pages may have the same signature size as the booklet pages and simply be added to the pages that form the booklet prior to binding. Alternatively, the inserted generic pages may differ widely from the booklet pages (for example, a post card or envelope) and be bound independently of the booklet body pages. Regardless, each recipient of the booklet will receive the same inserted generic pages. Further, there is no relationship between the custom text and the insert.

Booklets may also be produced using variable printers for both the covers and the bodies. When covers are required to be on a heavier weight of paper than the bodies, which is typically the case, only sheet-fed printers are currently capable of manufacturing these booklets both flawlessly and automatically. Current web-fed variable presses are not capable of printing on two weights of paper at the same time, and there is no current way of efficiently and automatically integrating customized booklets when variable web-fed presses are used to print booklet bodies, covers or both.

In summary, therefore, there is no current system or method that can take advantage of fully customized printing without the impediments of low speed and high cost. What would be useful would be a system and method that would allow the low-cost, high-speed output of offset and rotogravure presses to be joined with the output of fully-variable presses without possibility of error (i.e. without sending variable output intended to one recipient to a different recipient). Additionally, there is no current system or method that can take advantage of the relatively high speeds of web-fed variable presses to create booklets that have covers of a different type and/or weight than the booklet bodies. What would be useful would be a system and method that would allow the custom output of more than one variable press to be incorporated into the same document without possibility of error.

### BRIEF SUMMARY OF THE INVENTION

An embodiment of the present invention is a system and method for incorporating custom content from two printing sources into a booklet. In this embodiment of the present invention, a content control identifier is read from a pre-printed custom booklet component and sent to a content controller. The content controller uses the content control identifier to obtain instructions from a datastore and uses the instructions to create one or more “just-printed” custom booklet components and marry them to the pre-printed custom booklet component to create a customized booklet.

By way of illustration and not as a limitation, a booklet body comprises one or more pre-printed, custom signatures each having a content control identifier that is read and communicated to a content controller. The content control identifier is used to trigger the creation of a custom cover that is “married” to the one or more preprinted signatures from which the content control identifier was read. The cover and the pre-printed custom signature(s) are bound as a single customized booklet for a targeted recipient.

In an alternate embodiment, a generic booklet body is printed on a web-fed press. The generic booklet body is designed to be combined with one or more pre-printed custom signatures each having a content control identifier that is read and communicated to a content controller. The content control identifier is used to trigger the personalization (for example, the addressing) of the generic output for a targeted recipient and to marry the preprinted signature from which the content control identifier was read to the personalized web-fed press output to form a customized booklet for the targeted recipient.

It is therefore an aspect of the present invention to use a content control identifier read from a pre-printed custom signature to generate a custom cover associated with the pre-printed custom signature to create a customized booklet for a targeted recipient.

It is another aspect of the present invention to use a content control identifier read from a pre-printed custom signature to generate a custom cover associated with the pre-printed custom signature and to marry the pre-printed custom signature, and the custom cover with a generic pre-printed signature to create a customized booklet for a targeted recipient.

It is still another aspect of the present invention to use a content control identifier read from a pre-printed custom signature to generate a custom cover associated with the pre-printed custom signature and to marry the pre-printed custom signature and the custom cover with a generic pre-printed signature selected for a targeted recipient to create a customized booklet for that targeted recipient.

It is yet another aspect of the present invention to use a content control identifier read from a pre-printed custom signature to generate a custom cover associated with the pre-printed custom signature and to marry the pre-printed custom signature and custom cover to a generic pre-printed signature and a generic pre-printed signature selected for a targeted recipient to create a customized booklet for that targeted recipient.

It is an aspect of the present invention to use a content control identifier read from a pre-printed custom signature to address a generic booklet body to a targeted recipient and to marry the pre-printed custom signature to the addressed booklet body to create a customized booklet for that targeted recipient.

It is another aspect of the present invention to use a content control identifier read from a pre-printed custom signature to address a generic booklet body to a targeted recipient and to insert personalized content into the generic booklet body directed to that targeted recipient, and to marry the pre-printed custom signature to the addressed/personalized booklet body to create a customized booklet for that targeted recipient.

It is still another aspect of the present invention to use a content control identifier read from a pre-printed custom signature to address a generic booklet body to a targeted recipient, to insert personalized content into the generic booklet body directed to that targeted recipient, and to marry the pre-printed custom signature to the addressed/personalized booklet body and a generic pre-printed signature selected specifically for that targeted recipient to create a customized booklet for that targeted recipient.

It is yet another aspect of the present invention to use a content control identifier read from a pre-printed custom signature to address a generic booklet body to a targeted recipient, to insert personalized content into the generic booklet body directed to that targeted recipient, and to marry the pre-printed custom signature to the addressed/personalized booklet body, a generic pre-printed signature, and a generic pre-printed signature selected specifically for that targeted recipient to create a customized booklet for that targeted recipient.

These and other aspects of the present invention will become apparent from a review of the general and detailed descriptions that follow.

An embodiment of the present invention is a system for incorporating custom content into a booklet. In this embodiment of the present invention, pre-printed custom signatures are delivered to a feeder/scanner. Each pre-printed custom signature comprises a content control identifier in a machine-readable format (MRF). For example, in one embodiment, each signature of the pre-printed custom content comprises a bar code that is readable by an optical scanner. In another embodiment, content control identifier is read by an RF scanner. In yet another embodiment the bar code is readable in two “dimensions,” while in still another embodiment the bar code is readable in three “dimensions.”

The content control identifier is read by the feeder/scanner and sent to a content controller. Based on the content control identifier, the specification of the booklet to be printed is obtained from a datastore and the content of a custom cover is determined. The controller instructs the feed/scanner to deliver the custom signature to a book assembler while instructing a printer to print the cover. The cover printing process is controlled so that the cover is delivered to the book assembler just after the last pre-printed custom signature arrives.

In another embodiment of the present invention, the system comprises a first feeder/scanner and a second feeder/scanner and the customized booklet further comprises a generic signature inserted into the pre-printed custom signature at a location determined by booklet specification. The booklet specification is accessed by the content controller using the content control identifier read from the pre-printed custom signature. The generic signature is feed by the second feeder/scanner to the booklet assembler under the control of the content controller.

In yet another embodiment of the present invention, the content control identifier is used to select a generic signature for a targeted from a set of candidate generic signatures based on criteria included in the booklet specification. The criteria may be a zip code, a state, or a city, or other profile information relating to the targeted recipient.

Additional embodiments of the present invention are directed to the personalization of the booklet body. Using the content control identifier, a content controller obtains information from a datastore that is directed to a custom content printer on a web-fed printer. The web-fed printer prints a booklet body including any just-in-time custom content derived from the datastore. By way of illustration and not as a limitation, just-in-time custom content comprises a text message directed to the customer identified by the content control identifier. The text message is printed as the web (paper roll) progresses through the web-fed printer. As the booklet body signatures are delivered to a booklet assembler, the pre-printed custom content is delivered to the booklet assembler so as to be in the correct location.

As will be apparent to those skilled in the art, personalization can be combined with custom covers, generic signatures, and selected generic signatures (previously described) without departing from the scope of the present invention.

### BRIEF DESCRIPTION OF THE DRAWINGS

FIG. 1 illustrates a customization system according to an embodiment of the present invention.

FIG. 2 illustrates the use of a content control identifier read from a pre-printed custom signature to generate a custom cover associated with the pre-printed custom signature to create a customized booklet for a targeted recipient according to an embodiment of the present invention.

FIG. 3 illustrates a process whereby a content control identifier read from a pre-printed custom signature is used to generate a custom cover associated with the pre-printed custom signature to create a customized booklet for a targeted recipient according to an embodiment of the present invention.

FIG. 4 illustrates the use of a content control identifier read from a pre-printed custom signature to generate a custom cover associated with the pre-printed custom signature and to marry the pre-printed custom signature, and the custom cover with a generic pre-printed signature to create a customized booklet for a targeted recipient according to an embodiment of the present invention.

FIGS. 5A and 5B illustrate a process whereby a content control identifier read from a pre-printed custom signature is used to generate a custom cover associated with the pre-printed custom signature and to marry the pre-printed custom signature, and the custom cover with a generic pre-printed signature to create a customized booklet for a targeted recipient according to an embodiment of the present invention.

FIG. 6 illustrates the use of a content control identifier read from a pre-printed custom signature to address a generic booklet body to a targeted recipient and to insert personalized content into the generic booklet body directed to that targeted recipient, and to marry the pre-printed custom signature to the addressed/personalized booklet body to create a customized booklet for that targeted recipient according to an embodiment of the present invention.

FIG. 7 illustrates a process whereby a content control identifier read from a pre-printed custom signature is used to address a generic booklet body to a targeted recipient and to insert personalized content into the generic booklet body directed to that targeted recipient, and to marry the pre-printed custom signature to the addressed/personalized booklet body to create a customized booklet for that targeted recipient according to an embodiment of the present invention.

### DETAILED DESCRIPTION OF THE PRESENT INVENTION

In describing the embodiments of the present invention, the following terms the following terms are defined for the sake of clarity:
Signature—a sheet of paper printed on both sides that, when optionally folded and included in a document or booklet, constitutes a number of pages always divisible by 2 and typically 4 or some other power of 2.
Booklet—a set of signatures in a defined order, typically, but not necessarily, bound together in book form.
Generic content—content that when printed produces a copy that is the same at those printed before or after.
Personalized content—generic content to which content directed to a particular targeted recipient is added during the printing or bindery operations on the generic content by a separate printing device (usually with an inkjet printer or similar device).
Custom content—content that when printed produces text and graphics that are intended for a specific targeted recipient, and bear no necessary relationship to any content intended to any other recipient.

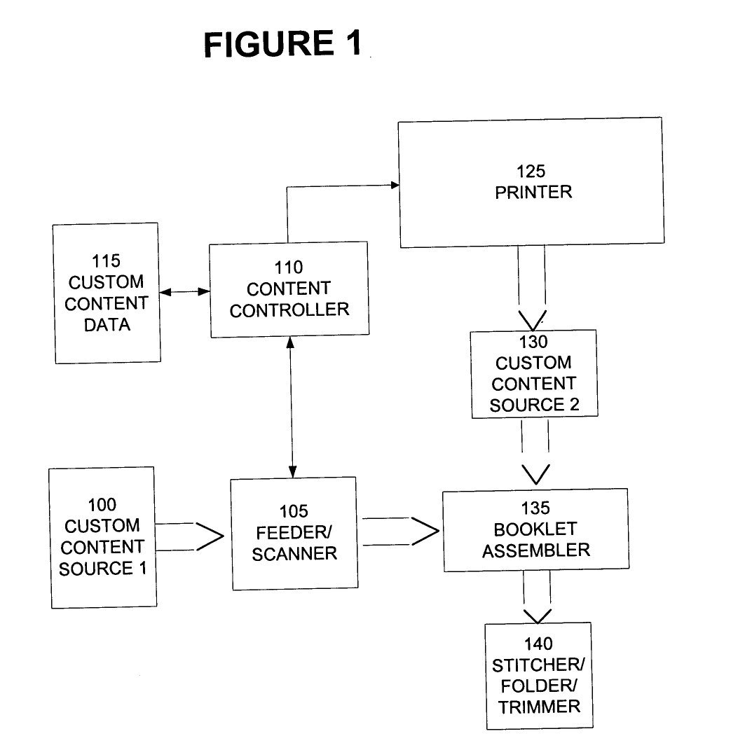

An embodiment of the present invention is a system and method for incorporating custom content from two printing sources into a booklet. Referring to FIG. 1, a content control identifier is read from a custom content source 1 100 by a feeder/scanner 105 and sent to a content controller 110. The content controller 110 uses the content control identifier to obtain content data 115. The content controller 110 then directs the content data 115 to printer 125. The output of printer 125 is custom content source 2 130. The content controller 110 uses the content data to marry the content of custom content source 1 100 and custom content source 2 130 at book assembler 135 in the proper order to create a customized booklet. The booklet signatures are then sent to a stitcher/folder/trimmer 145 for finishing.

In an exemplary embodiment of the present invention, a booklet body comprises one or more pre-printed, custom signatures (custom content source 1) each having a content control identifier that is read and communicated to a content controller. The content control identifier is used to trigger the creation of a custom cover (custom content source 2) that is “married” to the one or more preprinted signatures from which the content control identifier was read. The cover and the pre-printed custom signature(s) are bound as a single customized booklet for a targeted recipient.

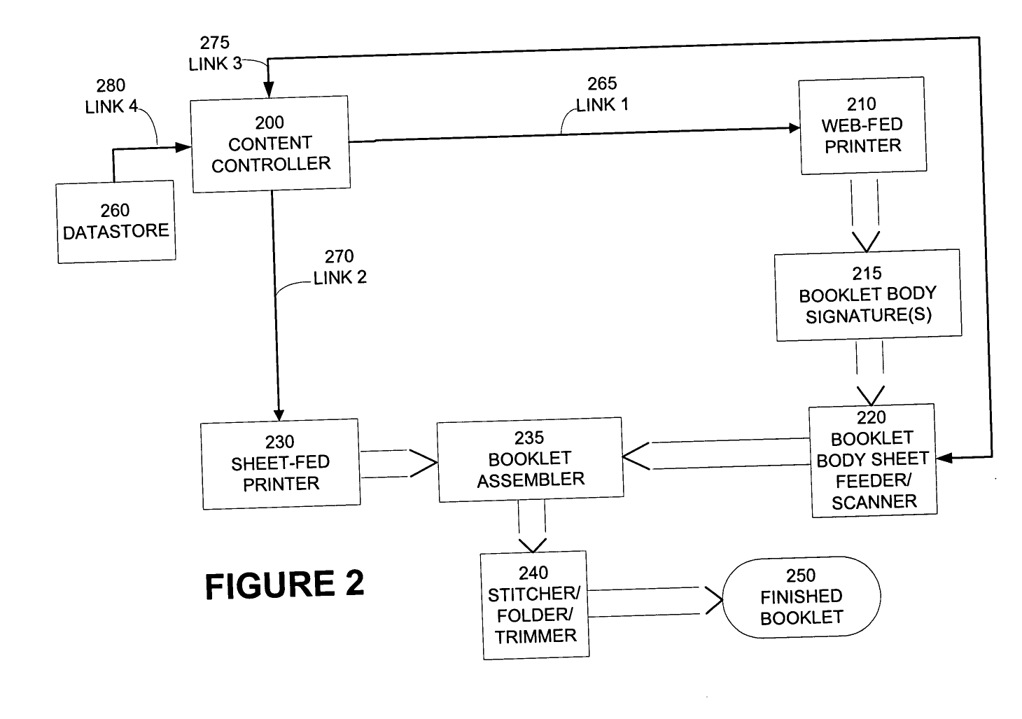

FIG. 2 illustrates the use of a content control identifier read from a pre-printed custom signature to generate a custom cover associated with the pre-printed custom signature to create a customized booklet for a targeted recipient according to an embodiment of the present invention. Referring to FIG. 2, a content controller 200 is linked to a web-fed printer 210 via link 1 265. The content controller 200 is also linked to a sheet-fed printer 230. A booklet body sheet feeder/scanner 220 is linked to content controller 200 via a link 3 275. A datastore 260 is linked to the content controller 200 via a link 4 280.

The datastore 260 comprises a specification for a booklet. In this embodiment, the booklet specification comprises a booklet filename, a cover code (identifying a cover to be used with the pre-printed custom signature), and information relating to a targeted recipient. However, this is not meant as a limitation. The booklet specification may comprise other information without departing from the scope of the present invention. While the datastore 260 is illustrated as a single entity, the present invention is not so limited. As will be apparent to those skilled in the art, the tasks assigned to the datastore 260 may be performed by any number of computer and storage technologies without departing from the scope of the present invention. By way of illustration, the datastore 260 may be a storage area network or a file server.

The output of web-fed printer 210 is one or more booklet body signatures 215 each of which is marked with a content control identifier. Collectively, the one or more booklet body signatures 215 comprise a booklet body. The content control identifier relates the booklet body to a booklet specification held in datastore 260. The booklet body signatures 215 are fed to the booklet body sheet feeder/scanner 220. The content control identifier is read by the booklet body sheet feeder/scanner 220 and the information conveyed to the content controller 200 via link 3 275.

The sheet-fed printer 230 is under the control of the content controller 200. The output of sheet-fed printer 230 is a cover of a booklet customized for the booklet body identified by the content control identifier. The sheet-fed printer 230 output and the booklet body sheet feeder/scanner 220 output are merged by booklet assembler 235. The output of booklet assembler 235 is delivered to stitcher/folder/trimmer 240 where the booklets are trimmed, bound, and finished. The output of stitcher/folder/trimmer 240 is a finished booklet 250.

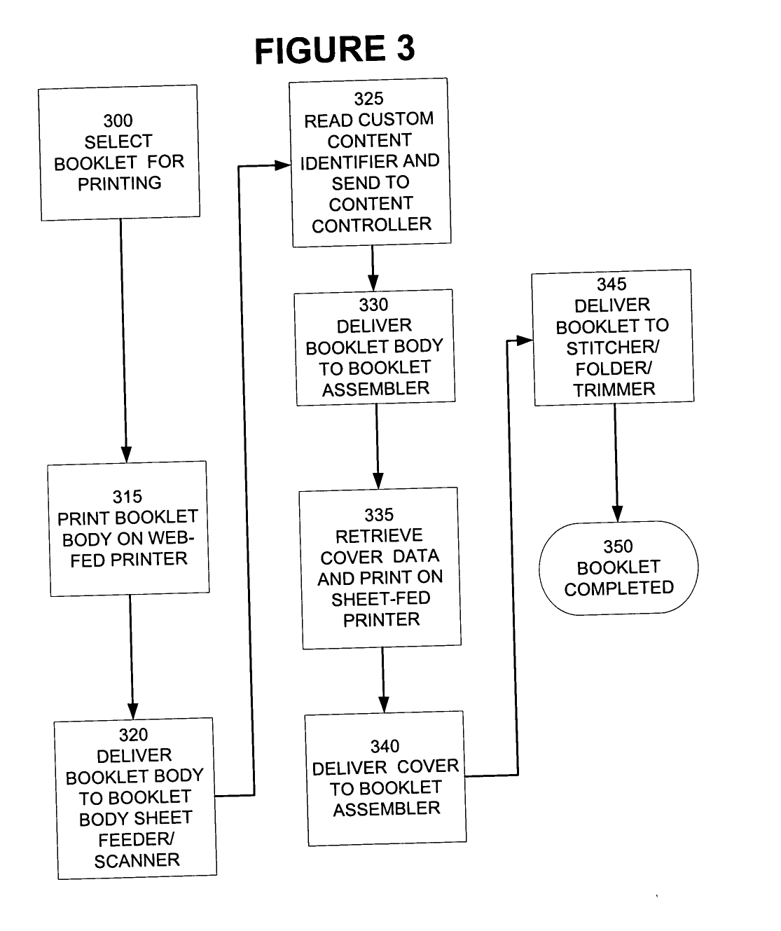

FIG. 3 illustrates a process whereby a content control identifier read from a pre-printed custom signature is used to generate a custom cover associated with the pre-printed custom signature to create a customized booklet for a targeted recipient according to an embodiment of the present invention. Referring to FIG. 3, a booklet is selected for printing 300. While FIG. 3 describes the selection of a singular “booklet”, the singular reference is used for clarity purposes and not as a limitation. Any number of booklets (limited only by hardware metrics) may be chosen for printing at any time without departing from the scope of the present invention. A content control identifier relates a booklet to its specification. In this embodiment, the booklet specification comprises a booklet filename, a cover code (identifying a cover to be used with the pre-printed custom signature), and information relating to a targeted recipient. However, this is not meant as a limitation. The booklet specification may comprise other information without departing from the scope of the present invention.

The data representing the content of the booklet body is retrieved from a datatstore by the content controller and printed on a web-fed printer 315. The content control identifier is printed in the margin area of each signature. The margin area is removed during the trimming and assembly operation (described below).

One or more booklet bodies are delivered to a booklet body sheet feeder/scanner 320. The sheet feeder/scanner/reads the content control identifier and sends the results to a content controller 325. The booklet body is delivered to a booklet assembler 330. Based on the content control identifier, the content controller retrieves the cover content data from the datastore, and sends the cover content data to be printed on a sheet-fed printer 335. In this way, the weight, texture, and color of the cover may be different from that used to print the booklet body. The cover is delivered to a booklet assembler 340. The booklet is delivered to a stitcher/folder/trimmer for binding 345. A finished booklet 350 is ready for distribution.

In still another embodiment of the present invention, booklets having common booklet bodies may be printed in the same printing run with different covers based on profile information of the intended recipient or other information. In this embodiment, the booklet bodies, while common in terms of content, have different content control identifiers.

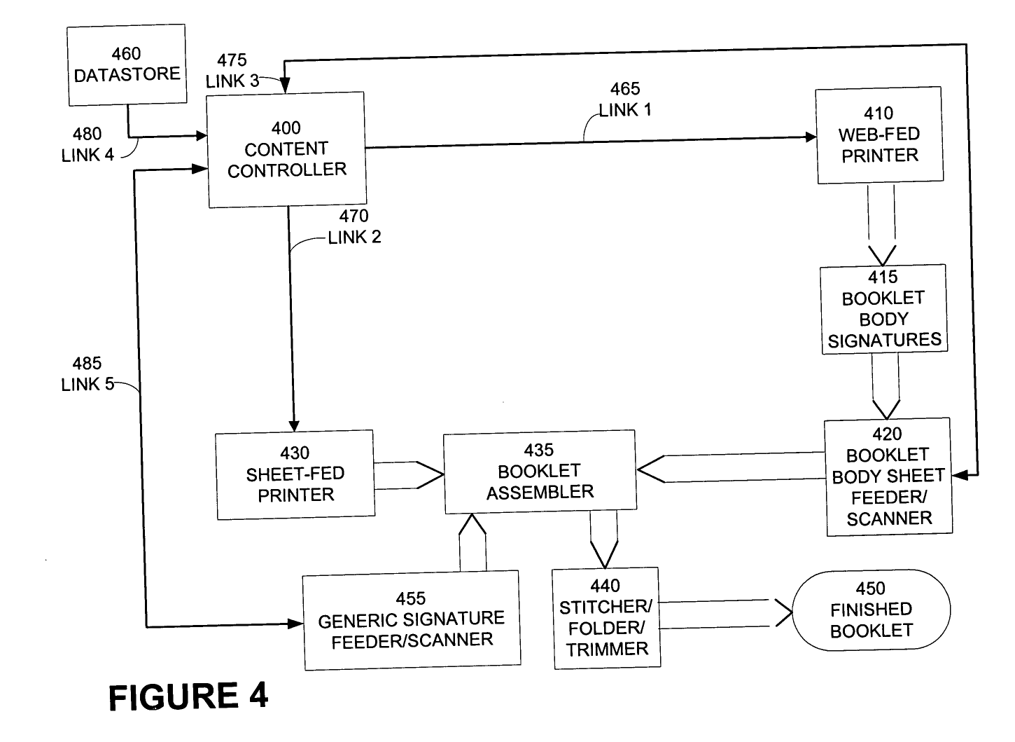

FIG. 4 illustrates the use of a content control identifier read from a pre-printed custom signature to generate a custom cover associated with the pre-printed custom signature and to marry the pre-printed custom signature, and the custom cover with a generic pre-printed signature to create a customized booklet for a targeted recipient according to an embodiment of the present invention. Referring to FIG. 4, a content controller 400 is linked to a web-fed printer 410. The content controller 400 is also linked to a sheet-fed printer 430. A booklet body sheet feeder/scanner 420 is linked to content controller 400 via a link 3 475. A datastore 460 is linked to the content controller 400 via a link 4 480. The content controller is also linked to a generic sheet feeder/scanner 455 via a link 5 485.

The datastore 460 comprises a specification for a booklet. In this embodiment, the booklet specification comprises a booklet filename, a cover code (identifying a cover to be used with the pre-printed custom signatures), information relating to a targeted recipient, one or more generic content identifiers to identify the generic signatures that are to be inserted in the booklet body, and location data that determine where each generic signature is to be inserted within the booklet. However, this is not meant as a limitation. The booklet specification may comprise other information without departing from the scope of the present invention. While the datastore 460 is illustrated as a single entity, the present invention is not so limited. As will be apparent to those skilled in the art, the tasks assigned to the datastore 460 may be performed by any number of computer and storage technologies without departing from the scope the present invention. By way of illustration, the datastore 460 may be a storage area network or a file server.

The output of web-fed printer 410 is one or more booklet body signatures 415 each of which is marked with a content control identifier. Collectively, the one or more booklet body signatures 415 comprise a booklet body. The content control identifier relates the booklet body to a booklet specification held in datastore 460. The booklet body signatures 415 are fed to the booklet body sheet feeder/scanner 420. The content control identifier is read by the booklet body sheet feeder/scanner 420 and the information conveyed to the content controller 400 via link 3 475.

The sheet-fed printer 430 is under the control of the content controller 400. The output of sheet-fed printer 430 is a cover of a booklet customized for the booklet body identified by the content control identifier. Booklet assembler 435 accepts the cover signature from sheet-fed printer 430, sheet feeder/scanner 420, and generic signature feeder 455 (which dispenses generic signatures as described below). Booklet assembler 435 merges signatures from these three sources to produce an integrated customized booklet. The output of booklet assembler 435 is delivered to stitcher/folder/trimmer 440 where the booklets are trimmed, bound, and finished. The output of stitcher/folder/trimmer 440 is a finished booklet 450. This booklet comprises a cover, the booklet body, and the generic signatures.

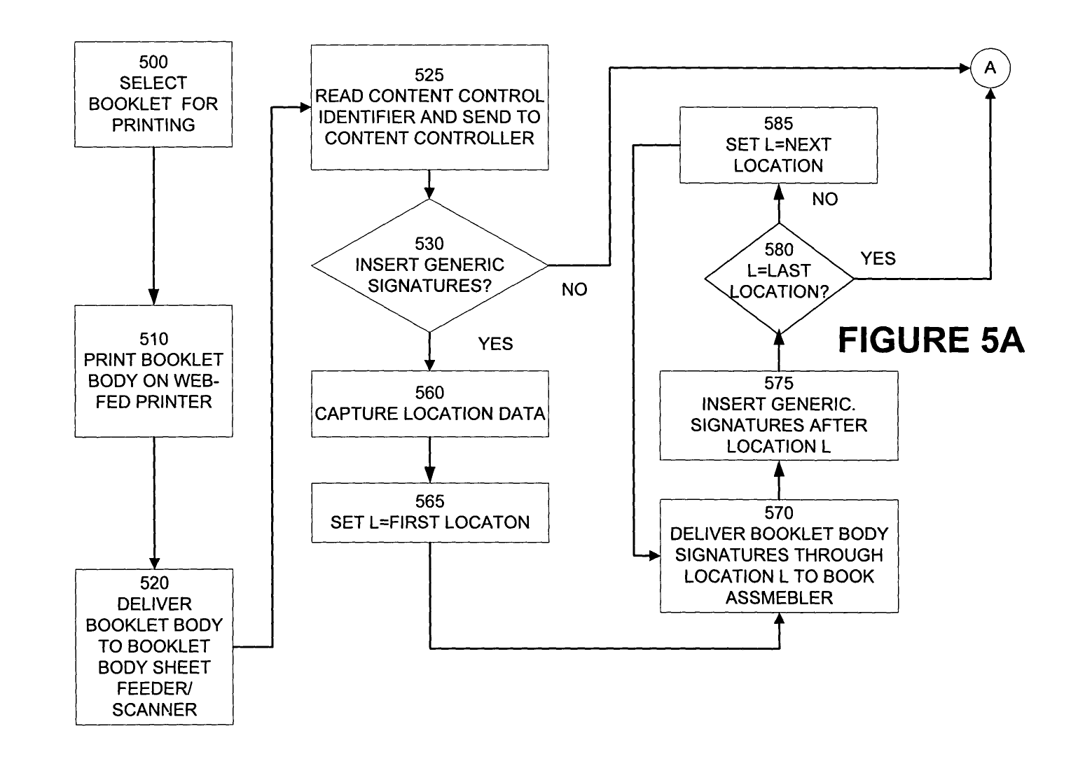

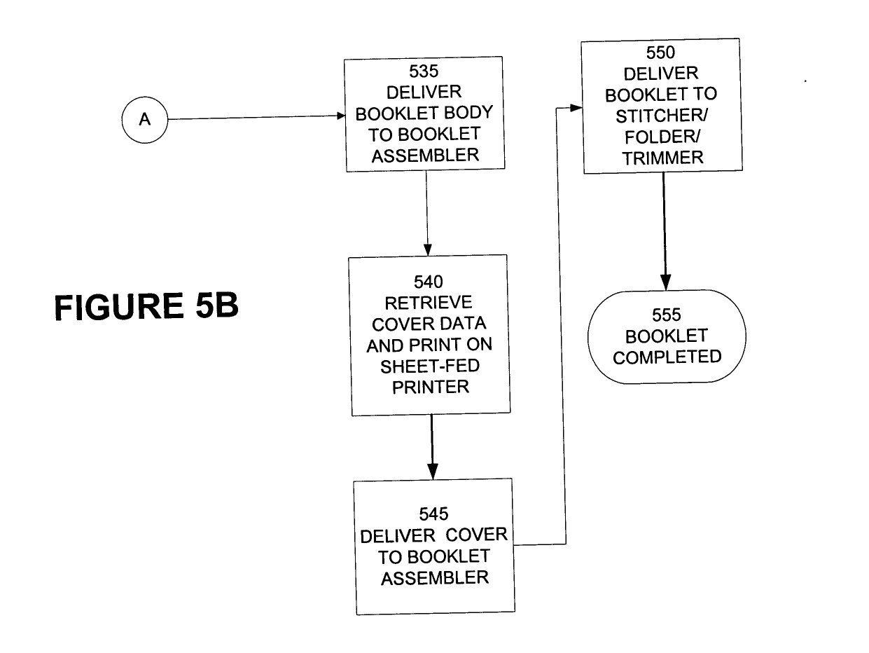

FIGS. 5A and 5B illustrate a process whereby a content control identifier read from a pre-printed custom signature is used to generate a custom cover associated with the pre-printed custom signature and to marry the pre-printed custom signature, and the custom cover with a generic pre-printed signature to create a customized booklet for a targeted recipient according to an embodiment of the present invention. Referring to FIG. 5A, a booklet is selected for printing 500. While FIG. 5 describes the selection of a singular “booklet”, the singular reference is used for clarity purposes and not as a limitation. Any number of booklets (limited only by hardware metrics) may be chosen for printing at any time without departing from the scope of the present invention. A content control identifier relates a booklet to its specification. In this embodiment, the booklet specification comprises a booklet filename, a cover code (identifying a cover to be used with those signatures), information relating to a targeted recipient, one or more generic content identifiers to identify the generic signatures that are to be inserted in the booklet body, and location data that determine where each generic signature is to be inserted within the booklet. However, this is not meant as a limitation. The booklet specification may comprise other information without departing from the scope of the present invention.

The data representing the content of the booklet body is retrieved from a datatstore by the content controller and printed on a web-fed printer 510. The printing process produces a desired number of booklet bodies for each booklet printed. The content control identifier of a booklet is printed in the margin area that is typically removed during the trimming and assembly operation.

One or more booklet bodies are delivered to a sheet feeder/scanner 520. The sheet feeder/scanner/reads the content control identifier 525 and sends the results to a custom content controller. The content controller determines if generic signatures are to be merged with the booklet bodies 530. If the booklet does not require generic pre-printed signatures, the booklet body is delivered to a booklet assembler 535. The content controller retrieves the cover content data for the cover signature based on the content control identifier, and sends the cover content data to and printed on the sheet-fed printer 540. The cover is delivered to a booklet assembler 545. The booklet is delivered to a stitcher/folder/trimmer for binding 550. A finished booklet 555 is ready for distribution.

If the booklet requires generic signatures, the location data where the generic signatures are to be inserted is derived from the booklet specification selected using the content control identifier 560. As illustrated in FIG. 5A, the location data indicates that generic signatures are to be inserted after a specific location within the booklet body. However, this is not meant as a limitation. For example, location data may identify placement of generic signatures before a location within the booklet body. In another embodiment, location data may be relative to a cover.

Based on the content control identifier, an index “L” is set to the first location where generic signatures are to be inserted 565. Booklet body signatures are delivered through location “L” 570 and one or more generic signatures are inserted after location “L” 575. A determination is made if location “L” is the last location for the insertion of generic signatures 580. If “L” is the last location, the process continues 535. If “L” is not the last location, “L” is set to the “next location” 585 for insertion of generic signatures and the process continues with the delivery of booklet body signatures through location “L” (equal to “next location”) 570. The process of inserting generic signatures continues until the last location is reached and the generic signatures for that location are inserted. A custom cover is added as previously described and the booklet is delivered to a stitcher/folder/trimmer for binding 550. A finished booklet 555 is ready for distribution.

FIG. 5 illustrates an embodiment of the present invention in which each signature of a booklet body is checked to determine whether generic signatures are to be inserted after a specified location. As will be appreciated by those skilled in the art of the present invention, other means may be used to determine the insertion point of the generic signatures without exceeding the scope of the present invention.

In yet another embodiment of the present invention, the content control identifier is used to select a generic signature for a targeted recipient from a set of candidate generic signatures based on criteria included in the booklet specification. The criteria may be a zip code, a state, or a city, or other profile information relating to the targeted recipient. By way of illustration and not as a limitation, a sporting goods catalogue in the form of pre-printed custom signature is prepared as previously discussed for a targeted recipient. The content control identifier identifies the catalogue as directed to the targeted recipient. An insert comprising generic signatures is prepared for each professional football team. Targeted recipients having an address within the market of a professional football team will receive the custom sports catalogue, an insert for that team, and a custom cover addressed to the targeted recipient and announcing the inclusion of the insert. A targeted recipient whose address is not within the market of a professional football team will receive the custom sports catalogue and custom cover addressed to the targeted recipient but no insert. In this embodiment, the generic content is selected for the targeted recipient based on the identity of the target recipient (as revealed by the content control identifier) and information about the targeted recipient that is included in the booklet specification. As will be apparent to those skilled in the art, a booklet as described in this example may also comprise generic content that is not selected (e.g., every catalogue recipient gets a football schedule but only those located in a football market receive a team insert).

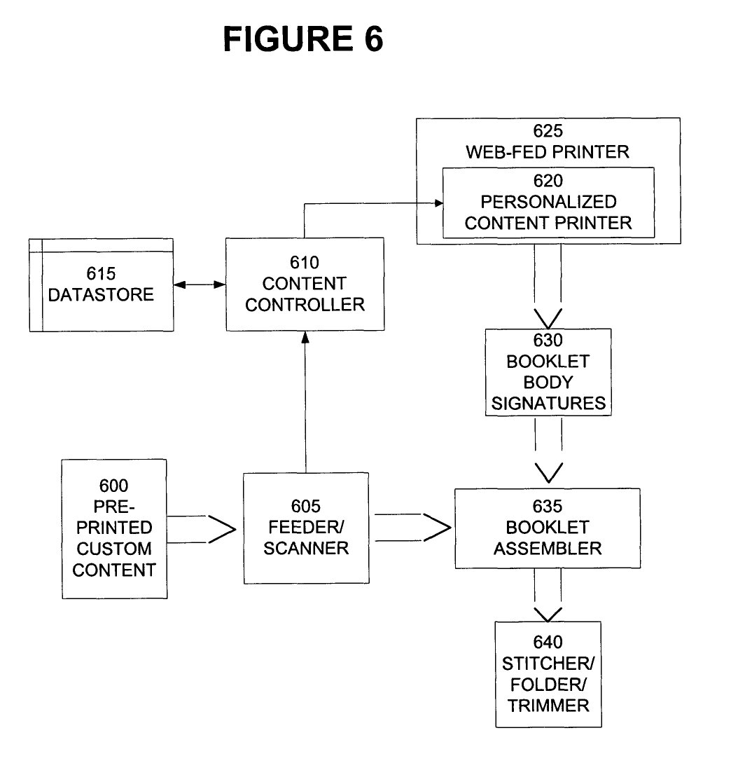

Embodiments of the present invention are also directed to personalization of booklets. FIG. 6 illustrates the use of a content control identifier read from a pre-printed custom signature to address a generic booklet body to a targeted recipient and to insert personalized content into the generic booklet body directed to that targeted recipient, and to marry the pre-printed custom signature to the addressed/personalized booklet body to create a customized booklet for that targeted recipient according to an embodiment of the present invention.

Referring to FIG. 6, a block diagram of a customization system according to an embodiment of the present invention is illustrated. In this embodiment of the present invention, pre-printed custom content 600 is delivered to feeder/scanner 605. By way of illustration and not as a limitation, pre-printed custom content may be a unique booklet cover or an insert. Using the content control identifier, a content controller 610 obtains information from a datastore 615 that is directed to a personalized content printer 620 on a web-fed printer 625. The web-fed printer 625 prints a booklet body 630 including personalized content derived from the datastore 615. By way of illustration and not as a limitation, personalized content comprises a text message directed to the customer identified by the content control identifier. By way of illustration and not as a limitation, the text message may be a customer name and address, mail-sorting information, or a friendly message. A specific text message is printed in the location designated for that message by a personalized content printer as the web (paper roll) progresses through the web-fed printer. As will be apparent to those skilled in the art, a web press may incorporate one or more personalized content printers without departing from scope of the present invention.

As the booklet body signatures are delivered to a booklet assembler 635, the pre-printed custom content is delivered to the booklet assembler 635 so as to be in the correct location to be inserted into the booklet in which the custom content associated with the content control identifier has been incorporated. The booklet signatures are then sent to a stitcher/folder/trimmer 640 for finishing.

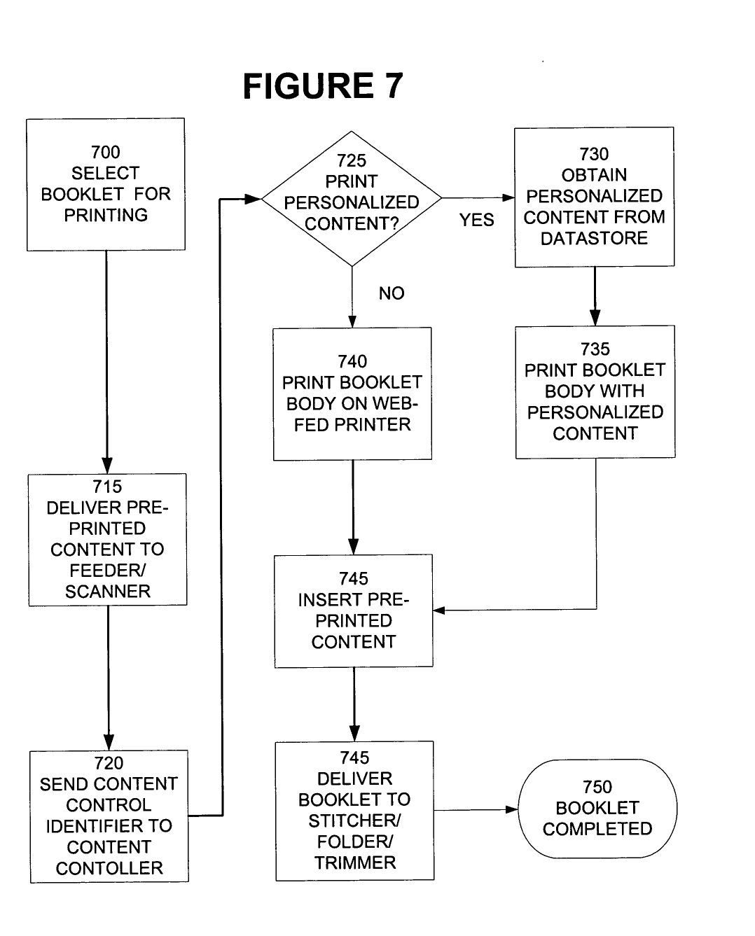

Referring to FIG. 7, a process for inserting custom content into a booklet according to an embodiment of the present invention is illustrated. A booklet is selected for printing 700. While FIG. 7 describes the selection of a singular “booklet”, the singular reference is used for clarity purposes and not as a limitation. Any number of booklets (limited only by hardware metrics) may be chosen for printing at any time without departing from the scope of the present invention. A content control identifier relates a booklet to its specification. In this embodiment, the booklet specification comprises a booklet filename, personalized content, and information relating to a targeted recipient. However, this is not meant as a limitation. The booklet specification may comprise other information without departing from the scope of the present invention.

Pre-printed custom content is delivered to a feeder/scanner 715. The content control identifier is read from the pre-printed content and sent to the content controller 720. A determination is made whether personalized content is associated with the pre-printed custom content 725. If custom personalized content is not associated with the pre-printed content, the booklet is printed on a web-fed printer 740, the pre-printed content is inserted in the booklet body at the designated location, and the completed booklet is delivered to a stitcher/folder/trimmer for binding 745. A finished booklet 750 is ready for distribution. If custom content is associated with the pre-printed content, the content controller obtains the content information from the datastore 730 and directs the content information to a custom personalized content printer incorporated into the web-fed printer 735 for printing at the predetermined location in the booklet body. The pre-printed content is then inserted as previously described and the customized booklet is completed.

In another embodiment of the present invention, a content control identifier read from a pre-printed custom signature is used to address a generic booklet body to a targeted recipient, to insert personalized content into the generic booklet body directed to that targeted recipient, and to marry a pre-printed custom signature to the addressed/personalized booklet body and a generic pre-printed signature selected for that targeted recipient to create a customized booklet for that targeted recipient.

It yet another embodiment of the present invention, a content control identifier read from a pre-printed custom signature to address a generic booklet body to a targeted recipient, to insert personalized content into the generic booklet body directed to that targeted recipient, and to marry the pre-printed custom signature to the addressed/personalized booklet body, a generic pre-printed signature, and a generic pre-printed signature selected for that targeted recipient to create a customized booklet for that targeted recipient

A system and method for incorporating custom content into a booklet has now been illustrated. It will be understood by those skilled in the art of the present invention may be embodied in other specific forms without departing from the scope of the invention disclosed and that the examples and embodiments described herein are in all respects illustrative and not restrictive. Those skilled in the art of the present invention will recognize that other embodiments using the concepts described herein are also possible.

1. A booklet system comprising:
a pre-printed custom booklet component directed to a targeted recipient and having a content control identifier;
a content controller, wherein the content controller is adapted to:
use the content control identifier received from the pre-printed custom booklet component to obtain instructions;
use the instructions to create a just-printed custom booklet component; and
use the instructions to marry the pre-printed custom booklet component and the just-printed custom booklet component to produce a customized booklet directed to the targeted recipient.

2. The booklet system of claim 1, wherein the content control identifier is a machine-readable code.

3. The booklet system of claim 1, wherein the system further comprises a feeder/scanner adapted to receive the pre-printed custom booklet component, to read the content control identifier, and to send the content control identifier to the content controller.

4. The booklet system of claim 1, wherein the pre-printed custom booklet component comprises one or more signatures printed on a web-fed printer and customized for the targeted recipient and the just-printed custom booklet component comprises a cover printed on a sheet-fed printer.

5. The booklet system of claim 4, wherein the booklet system further comprises a pre-printed generic booklet component and wherein the content controller is further adapted to use the instructions to marry the pre-printed custom booklet component, the just-printed custom booklet component, and the pre-printed generic booklet component to produce a customized booklet directed to the targeted recipient.

6. The booklet system of claim 5 wherein the content control identifier is associated with profile data of the targeted recipient and the pre-printed generic booklet component is selected from a set of pre-printed generic booklet components for inclusion in the customized booklet based on the profile data.

7. The booklet system of claim 6, wherein the profile data of the targeted recipient is selected from the group consisting of an address, a set of preferences, a set of demographic data, and a set of historical data.

8. The booklet system of claim 1, wherein the booklet is selected from the group consisting of a book, a catalogue, a program, a service manual, a periodical, a report, a legal agreement, and a training manual.

9. A booklet system comprising:
a pre-printed custom booklet component directed to a targeted recipient and having a content control identifier;
a pre-printed generic booklet component;
a content controller, wherein the content controller is adapted to:
use the content control identifier received from the pre-printed custom booklet component to obtain instructions;
use the instructions to create a just-printed custom booklet component; and
use the instructions to marry the pre-printed custom booklet component, the just-printed custom booklet component, and the pre-printed generic custom booklet component to produce a customized booklet directed to the targeted recipient.

10. The booklet system of claim 9, wherein the content control identifier is a machine readable code.

11. The booklet system of claim 9, wherein the system further comprises a feeder/scanner adapted to receive the pre-printed booklet component, to read the content control identifier, and to send the content control identifier to the content controller.

12. The booklet system of claim 9, wherein the pre-printed booklet component comprises one or more signatures printed on a web-fed printer and customized for the targeted recipient and the just-printed custom booklet component comprises a cover printed on a sheet-fed printer.

13. The booklet system of claim 9 wherein the content control identifier is associated with profile data of the targeted recipient and the pre-printed generic booklet component is selected from a set of pre-printed generic booklet components for inclusion in the customized booklet based on the profile data.

14. The booklet system of claim 13, wherein the profile data of the targeted recipient is selected from the group consisting of an address, a set of preferences, a set of demographic data, and a set of historical data.

15. The booklet system of claim 9, wherein the booklet is selected from the group consisting of a book, a catalogue, a program, a service manual, a periodical, a report, a legal agreement, and a training manual.

16. A booklet system comprising:
a pre-printed custom booklet component directed to a targeted recipient and having a content control identifier;
a pre-printed generic booklet component;
one or more pre-printed targeted generic booklet components;
a content controller, wherein the content controller is adapted to:
use the content control identifier received from the pre-printed custom booklet component to obtain instructions;
use the instructions to create a just-printed custom booklet component;
use the instructions to determine if the targeted recipient is to receive at least one of the one or more pre-printed targeted generic booklet components;
in the event the targeted recipient is to receive at least one of the one or more pre-printed targeted generic booklet components, identify each of the one or more pre-printed targeted generic booklet components the targeted recipient is to receive;
use the instructions to marry the pre-printed custom booklet component, the just-printed custom booklet component, the pre-printed generic custom booklet component, and each pre-printed targeted booklet component the targeted recipient is to receive to produce a customized booklet directed to the targeted recipient.

17. The booklet system of claim 16, wherein the content control identifier is a machine readable code.

18. The booklet system of claim 16, wherein the system further comprises a feeder/scanner adapted to receive the pre-printed booklet component, to read the content control identifier, and to send the content control identifier to the content controller.

19. The booklet system of claim 16, wherein the pre-printed booklet component comprises one or more signatures printed on a web-fed printer and customized for the targeted recipient, and the just-printed custom booklet component comprises a cover printed on a sheet-fed printer.

20. The booklet system of claim 16 wherein the content control identifier is associated with profile data of the targeted recipient and the pre-printed targeted generic booklet component is selected for inclusion in the customized booklet based on the profile data.

21. The booklet system of claim 20, wherein the profile data of the targeted recipient is selected from the group consisting of an address, a set of preferences, a set of demographic data, and a set of historical data.

22. The booklet system of claim 21, wherein the booklet is selected from the group consisting of a book, a catalogue, a program, a service manual, a periodical, a report, a legal agreement, and a training manual.

23. A booklet system comprising:
a pre-printed custom booklet component directed to a targeted recipient and having a content control identifier;
a web-fed printer having a personalization printer integrated therewith, wherein the web-fed printer is adapted to print a just-printed booklet component;
a content controller, wherein the content controller is adapted to:
use the content control identifier received from the pre-printed custom booklet component to obtain instructions;
use the instructions to direct the personalization printer to print personalized content directed to the targeted recipient at a specified location in the just-printed booklet component; and
use the instructions to marry the pre-printed custom booklet component and the personalized just-printed booklet component to produce a customized booklet directed to the targeted recipient.

24. The booklet system of claim 23, wherein the content control identifier is a machine-readable code.

25. The booklet system of claim 23, wherein the system further comprises a feeder/scanner adapted to receive the pre-printed custom booklet component, to read the content control identifier, and to send the content control identifier to the content controller.

26. The booklet system of claim 23, wherein the personalized content is an address.

27. The booklet system of claim 23, wherein the personalized content is a message.

28. The booklet system of claim 23, wherein the content control identifier is associated with profile data of the targeted recipient and the personalized content is based on the profile data.

29. The booklet system of claim 28, wherein the profile data of the targeted recipient is selected from the group consisting of an address, a set of preferences, a set of demographic data, and a set of historical data.

30. The booklet system of claim 23, wherein the content controller is further adapted to use the instructions to create a just-printed custom booklet component and to marry the pre-printed custom booklet component, the personalized just-printed booklet component, and the just-printed custom booklet component to produce a customized booklet directed to the targeted recipient.

31. The booklet system of claim 30, wherein the pre-printed custom booklet component comprises one or more signatures printed on a web-fed printer and customized for the targeted recipient, and the just-printed custom booklet component comprises a cover printed on a sheet-fed printer.

32. The booklet system of claim 23, wherein the booklet system further comprises a pre-printed generic booklet component and wherein the content controller is further adapted to use the instructions to marry the pre-printed custom booklet component, the personalized just-printed booklet component, and the pre-printed generic booklet component to produce a customized booklet directed to the targeted recipient.

33. The booklet system of claim 32 wherein the content control identifier is associated with profile data of the targeted recipient, and the pre-printed generic booklet component is selected from a set of pre-printed generic booklet components for inclusion in the customized booklet based on the profile data.

34. The booklet system of claim 23, wherein the booklet is selected from the group consisting of a book, a catalogue, a program, a service manual, a periodical, a report, a legal agreement, and a training manual.

35. A booklet system comprising:
a pre-printed custom booklet component directed to a targeted recipient and having a content control identifier
means to read the content control identifier to obtain instructions;
means to use the instructions to create a just-printed custom booklet component;
means to use the instructions to marry the pre-printed custom booklet component with the just-printed custom booklet component to produce a customized booklet directed to the targeted recipient.

36. The booklet system of claim 35, the system further comprising:
a pre-printed generic booklet component; and
means to use the instructions to marry the pre-printed custom booklet component, the just-printed custom booklet component, and the pre-printed generic booklet component to produce a customized booklet directed to the targeted recipient.

37. A booklet system comprising:
a pre-printed custom booklet component directed to a targeted recipient and having a content control identifier;
a web-fed printer having a personalization printer integrated therewith, wherein the web-fed printer is adapted to print a just-printed booklet component;
means to read the content control identifier to obtain instructions;
means to use the instructions to direct the personalization printer to print personalized content directed to the targeted recipient at a specified location in the just-printed booklet component; and
means to use the instructions marry the pre-printed custom booklet component and the personalized just printed booklet component to produce a customized booklet directed to the targeted recipient.

38. The booklet system of claim 37, the system further comprising:
a pre-printed generic booklet component; and
means to use the instructions to marry the pre-printed custom booklet component, the just-printed custom booklet component and the pre-printed generic booklet component to produce a customized booklet directed to the targeted recipient.

39. A method for printing a booklet directed to a targeted recipient using a booklet system, the method comprising:
reading a content control identifier from a pre-printed custom booklet component;
using the content control identifier received from the pre-printed custom booklet component to obtain instructions;
using the instructions to create a just-printed custom booklet component; and
using the instructions marry the pre-printed custom booklet component with the just-printed custom booklet component to produce a customized booklet directed to the targeted recipient.

40. The method for printing a booklet directed to a targeted recipient using a booklet system of claim 39, wherein the content control identifier is a machine-readable code.

41. The method for printing a booklet directed to a targeted recipient using a booklet system of claim 39, wherein the pre-printed custom booklet component comprises one or more signatures printed on a web-fed printer and customized for the targeted recipient and the just-printed custom booklet component comprises a cover printed on a sheet-fed printer.

42. The method for printing a booklet directed to a targeted recipient using a booklet system of claim 41, the method further comprises using the instructions to marry the pre-printed custom booklet component and the just-printed custom booklet component with a pre-printed generic booklet component.

43. The method for printing a booklet directed to a targeted recipient using a booklet system of claim 39, wherein the content control identifier is associated with profile data of the targeted recipient and the method further comprises:
using the profile data to select a targeted pre-printed generic booklet component from a set of pre-printed generic booklet components for inclusion in the customized booklet based on the profile data; and
using the instructions to marry the pre-printed custom booklet component with the just-printed custom booklet component and the targeted generic book component to produce a customized booklet directed to the targeted recipient.

44. The method for printing a booklet directed to a targeted recipient using a booklet system of claim 43, wherein the profile data of the targeted recipient is selected from the group consisting of an address, a set of preferences, a set of demographic data, and a set of historical data.

45. The method for printing a booklet directed to a targeted recipient using a booklet system of claim 43, wherein the booklet is selected from the group consisting of a book, a catalogue, a program, a service manual, a periodical, a report, a legal agreement, and a training manual.

46. A method for printing a booklet directed to a targeted recipient using a booklet system, the booklet system comprising a web-fed printer having a personalization printer integrated therewith and wherein the web-fed printer is adapted to print a just-printed booklet component, the method comprising:
reading a content control identifier from a pre-printed custom booklet component;
using the content control identifier received from the pre-printed custom booklet component to obtain instructions;
using the instructions to direct the personalization printer to print personalized content directed to the targeted recipient at a specified location in a just-printed booklet component; and
using the instructions to marry the pre-printed custom booklet component with the personalized just printed booklet component to produce a customized booklet directed to the targeted recipient.

47. The method for printing a booklet directed to a targeted recipient using a booklet system of claim 46, wherein the content control identifier is a machine-readable code.

48. The method for printing a booklet directed to a targeted recipient using a booklet system of claim 46, wherein the system further comprises a feeder/scanner adapted to receive the pre-printed custom booklet component, to read the content control identifier, and to send the content control identifier to the content controller.

49. The method for printing a booklet directed to a targeted recipient using a booklet system of claim 46, wherein the personalized content is an address.

50. The method for printing a booklet directed to a targeted recipient using a booklet system of claim 46, wherein the personalized content is a message.

51. The method for printing a booklet directed to a targeted recipient using a booklet system of claim 46, wherein the content control identifier is associated with profile data of the targeted recipient and the personalized content is based on the profile data.

52. The method for printing a booklet directed to a targeted recipient using a booklet system of claim 51, wherein the profile data of the targeted recipient is selected from the group consisting of an address, a set of preferences, a set of demographic data, and a set of historical data.

53. The method for printing a booklet directed to a targeted recipient using a booklet system of claim 46, wherein the content controller is further adapted to use the instructions to create a just-printed custom booklet component and to use instructions to marry the pre-printed custom booklet component, the personalized just-printed booklet component, and the just-printed custom booklet component to produce a customized booklet directed to the targeted recipient.

54. The method for printing a booklet directed to a targeted recipient using a booklet system of claim 53, wherein the pre-printed custom booklet component comprises one or more signatures printed on a web-fed printer and customized for the targeted recipient and the just-printed custom booklet component comprises a cover printed on a sheet-fed printer.

55. The method for printing a booklet directed to a targeted recipient using a booklet system of claim 46, wherein the booklet system further comprises a pre-printed generic booklet component and wherein the content controller is further adapted to use the instructions to marry the pre-printed custom booklet component, the personalized just-printed booklet component, and the pre-printed generic booklet component to produce a customized booklet directed to the targeted recipient.

56. The method for printing a booklet directed to a targeted recipient using a booklet system of claim 55 wherein the content control identifier is associated with profile data of the targeted recipient and the pre-printed generic booklet component is selected from a set of pre-printed generic booklet components for inclusion in the customized booklet based on the profile data.

57. The method for printing a booklet directed to a targeted recipient using a booklet system of claim 46, wherein the booklet is selected from the group consisting of a book, a catalogue, a program, a service manual, a periodical, a report, a legal agreement, and a training manual.
